(19) United States
(12) Patent Application Publication
(10) Pub. No.: US 2025/0111600 A1
(43) Pub. Date: Apr. 3, 2025

(54) SPATIALLY ADAPTIVE SHADING RATES FOR DECOUPLED SHADING

(71) Applicants: Advanced Micro Devices, Inc., Santa Clara, CA (US); ATI Technologies ULC, Markham (CA)

(72) Inventors: Guennadi Riguer, Markham, CA (US); Michal Adam Wozniak, Santa Clara, CA (US)

(73) Assignees: Advanced Micro Devices, Inc., Santa Clara, CA (US); ATI Technologies ULC, Markham, CA (US)

(21) Appl. No.: 18/478,040

(22) Filed: Sep. 29, 2023

(51) Int. Cl. G06T 15/80; G06T 17/20

(52) U.S. Cl. CPC G06T 15/80; G06T 17/20

(57) ABSTRACT

A technique for rendering is provided. The technique includes performing a visibility pass that designates portions of shade space textures visible in a scene, wherein the visibility pass generates tiles that cover shade space textures visible in the scene; performing a rate controller operation on output of the visibility pass using spatially-adaptive sampling; performing a sparse shade space shading operation on the tiles that cover the shade space textures visible in the scene based on a result of the spatially-adaptive sampling; performing a regularization operation based on an output of the sparse shade space shading operation; and performing a reconstruction operation using output from the regularization operation to produce a final scene.

### BACKGROUND

Three-dimensional graphics processing involves rendering three-dimensional scenes by converting models specified in a three-dimensional coordinate system to pixel colors for an output image. Improvements to three-dimensional graphics processing are constantly being made.

### BRIEF DESCRIPTION OF THE DRAWINGS

A more detailed understanding may be had from the following description, given by way of example in conjunction with the accompanying drawings wherein:

FIG. 1 is a block diagram of an example computing device in which one or more features of the disclosure can be implemented;

FIG. 2 illustrates details of the device of FIG. 1 and an accelerated processing device, according to an example;

FIG. 3 is a block diagram showing additional details of the graphics processing pipeline illustrated in FIG. 2;

FIG. 4 illustrates a set of decoupled shading operations, according to an example;

FIG. 5 illustrates operations for the visibility pass and texture marking operations, according to an example;

FIG. 6 illustrates example shade space shading operations for the shade space shading operations of FIG. 4;

FIG. 7 illustrates an example reconstruction operation;

FIG. 8 illustrates implementation of spatially-adaptive shading rates, according to an example;

FIG. 9A illustrates regularly-spaced samples in shade space texture tile, according to an example;

FIG. 9B illustrates the clustering of samples around a high-frequency detail in shade space texture tile, according to an example;

FIG. 10A is a graph illustrating how the spatially-adaptive shading rate varies by distance without equalization, according to an example;

FIG. 10B is a graph illustrating how the spatially-adaptive shading rate varies by distance with equalization, according to an example;

FIGS. 11A and 11B illustrate a technique for adding additional spatial samples, according to an example;

FIG. 12 illustrates a feedback mechanism for adding additional spatial samples, determining whether the additional sample(s) provide information, and then adjusting the spatial sample rate up or down depending on the result, according to an example;

FIG. 13 illustrates a pattern for adding or subtracting samples employed with the feedback mechanism shown in FIG. 12, according to an example;

FIG. 14 illustrates a method for dithering the position of samples, according to an example; and

FIG. 15 is a flow diagram of a method for performing spatially-adaptive shading, according to an example.

### DETAILED DESCRIPTION

A technique for rendering is provided. The technique includes performing a visibility pass that designates portions of shade space textures visible in a scene, wherein the visibility pass generates tiles that cover shade space textures visible in the scene; performing a rate controller operation on output of the visibility pass using spatially-adaptive sampling; performing a sparse shade space shading operation on the tiles that cover the shade space textures visible in the scene based on a result of the spatially-adaptive sampling; performing a regularization operation based on an output of the sparse shade space shading operation; and performing a reconstruction operation using output from the regularization operation to produce a final scene.

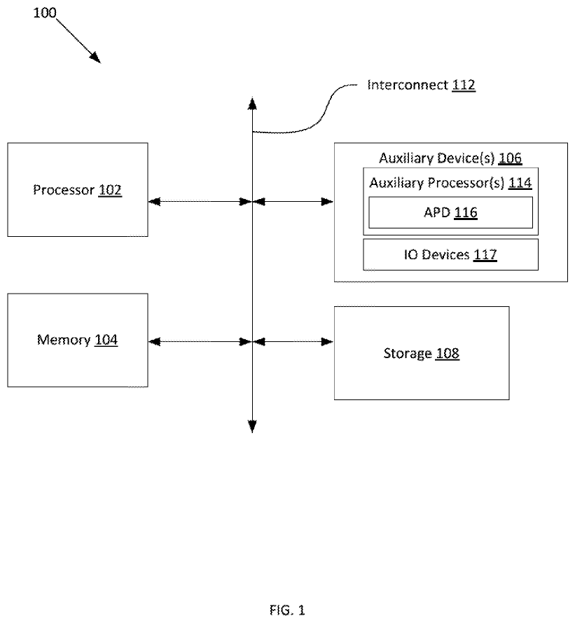

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary devices 106 includes an accelerated processing device (“APD”) 116. The APD 116 may be coupled to a display device, which, in some examples, is a physical display device or a simulated device that uses a remote display protocol to show output. The APD 116 is configured to accept compute commands and/or graphics rendering commands from processor 102, to process those compute and graphics rendering commands, and, in some implementations, to provide pixel output to a display device for display. As described in further detail below, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and, optionally, configured to provide graphical output to a display device. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm perform the functionality described herein.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

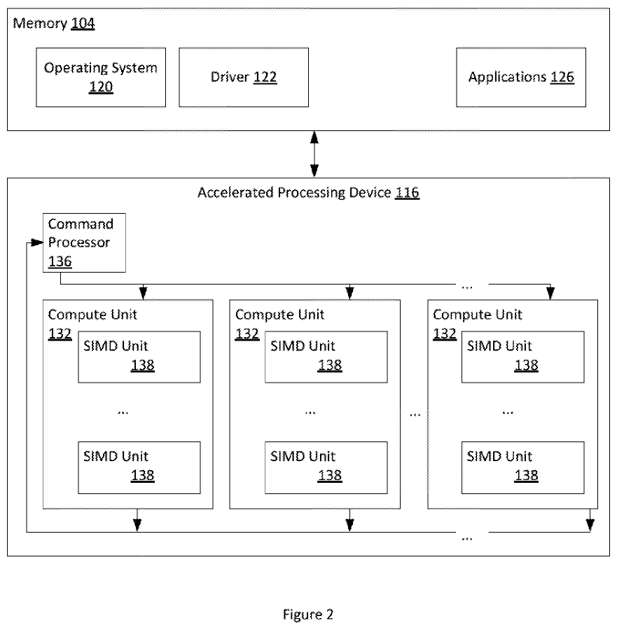

FIG. 2 illustrates details of the device 100 and the APD 116, according to an example. The processor 102 (FIG. 1) executes an operating system 120, a driver 122 (“APD driver 122”), and applications 126, and may also execute other software alternatively or additionally. The operating system 120 controls various aspects of the device 100, such as managing hardware resources, processing service requests, scheduling and controlling process execution, and performing other operations. The APD driver 122 controls operation of the APD 116, sending tasks such as graphics rendering tasks or other work to the APD 116 for processing. The APD driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to a display device based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that are configured to perform operations at the request of the processor 102 (or another unit) in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously (or partially simultaneously and partially sequentially) as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed on a single SIMD unit 138 or on different SIMD units 138. Wavefronts can be thought of as the largest collection of work-items that can be executed simultaneously (or pseudo-simultaneously) on a single SIMD unit 138. “Pseudo-simultaneous” execution occurs in the case of a wavefront that is larger than the number of lanes in a SIMD unit 138. In such a situation, wavefronts are executed over multiple cycles, with different collections of the work-items being executed in different cycles. A command processor 136 is configured to perform operations related to scheduling various workgroups and wavefronts on compute units 132 and SIMD units 138.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

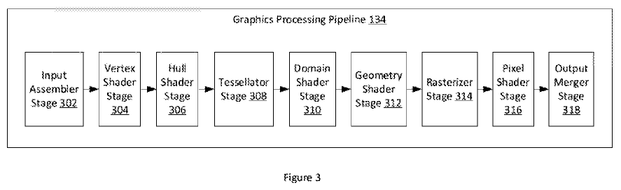

FIG. 3 is a block diagram showing additional details of the graphics processing pipeline 134 illustrated in FIG. 2. The graphics processing pipeline 134 includes stages that each performs specific functionality of the graphics processing pipeline 134. Each stage is implemented partially or fully as shader programs executing in the programmable compute units 132, or partially or fully as fixed-function, non-programmable hardware external to the compute units 132.

The input assembler stage 302 reads primitive data from user-filled buffers (e.g., buffers filled at the request of software executed by the processor 102, such as an application 126) and assembles the data into primitives for use by the remainder of the pipeline. The input assembler stage 302 can generate different types of primitives based on the primitive data included in the user-filled buffers. The input assembler stage 302 formats the assembled primitives for use by the rest of the pipeline.

The vertex shader stage 304 processes vertices of the primitives assembled by the input assembler stage 302. The vertex shader stage 304 performs various per-vertex operations such as transformations, skinning, morphing, and per-vertex lighting. Transformation operations include various operations to transform the coordinates of the vertices. These operations include one or more of modeling transformations, viewing transformations, projection transformations, perspective division, and viewport transformations, which modify vertex coordinates, and other operations that modify non-coordinate attributes.

The vertex shader stage 304 is implemented partially or fully as vertex shader programs to be executed on one or more compute units 132. The vertex shader programs are provided by the processor 102 and are based on programs that are pre-written by a computer programmer. The driver 122 compiles such computer programs to generate the vertex shader programs having a format suitable for execution within the compute units 132.

The hull shader stage 306, tessellator stage 308, and domain shader stage 310 work together to implement tessellation, which converts simple primitives into more complex primitives by subdividing the primitives. The hull shader stage 306 generates a patch for the tessellation based on an input primitive. The tessellator stage 308 generates a set of samples for the patch. The domain shader stage 310 calculates vertex positions for the vertices corresponding to the samples for the patch. The hull shader stage 306 and domain shader stage 310 can be implemented as shader programs to be executed on the compute units 132, that are compiled by the driver 122 as with the vertex shader stage 304.

The geometry shader stage 312 performs vertex operations on a primitive-by-primitive basis. A variety of different types of operations can be performed by the geometry shader stage 312, including operations such as point sprite expansion, dynamic particle system operations, fur-fin generation, shadow volume generation, single pass render-to-cubemap, per-primitive material swapping, and per-primitive material setup. In some instances, a geometry shader program that is compiled by the driver 122 and that executes on the compute units 132 performs operations for the geometry shader stage 312.

The rasterizer stage 314 accepts and rasterizes simple primitives (triangles) generated upstream from the rasterizer stage 314. Rasterization consists of determining which screen pixels (or sub-pixel samples) are covered by a particular primitive. Rasterization is performed by fixed function hardware.

The pixel shader stage 316 calculates output values for screen pixels based on the primitives generated upstream and the results of rasterization. The pixel shader stage 316 may apply textures from texture memory. Operations for the pixel shader stage 316 are performed by a pixel shader program that is compiled by the driver 122 and that executes on the compute units 132.

The output merger stage 318 accepts output from the pixel shader stage 316 and merges those outputs into a frame buffer, performing operations such as z-testing and alpha blending to determine the final color for the screen pixels.

It is possible to perform rendering in a “decoupled” manner. Decoupled rendering involves decoupling sample shading operations from other operations in the pipeline such as geometry processing and actual application of the shading results to the objects of a three-dimensional scene. In “typical” rendering such as forward rendering, a rendering pipeline processes triangles, transforming the vertices of such triangles from world space to screen space, then rasterizes the triangles, generating fragments for shading by the pixel shader. The pixel shader shades such fragments and outputs visible fragments to the pixel buffer for final output. As can be seen, in such rendering operations, the rate at which pixel shading operations occur is directly related to the rate at which the geometry sampling is performed during rasterization. Advantage can be gained by decoupling the rate at which shading operations occur from the rate at which other graphics pipeline operations occur. Specifically, it can be possible to reduce the heavy workload of complex pixel shading operations by reducing the spatial shading rate associated with low frequency spatial information.

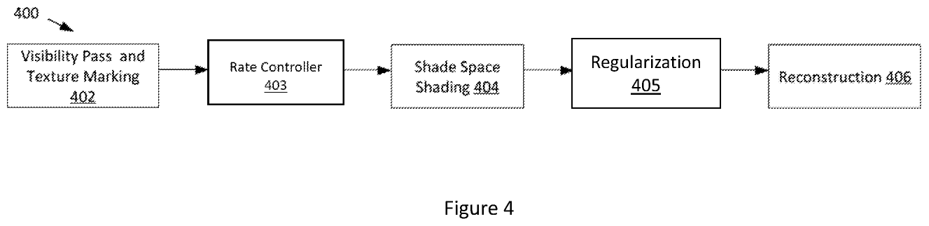

FIG. 4 illustrates a set of decoupled shading operations 400, according to an example. The set of decoupled shading operations 400 includes a visibility pass and shade space marking operation 402, a shading rate determination phase 403, a shade space shading operation 404, a regularization operation 405, and a reconstruction operation 406. In some examples, any of these operations is performed by one or more of software executing on a processor (such as the compute units 132), hardware (e.g., hard-wired circuitry), or a combination of software and hardware. In various examples, any of this software includes software executing on the processor 102 (e.g., an application), software executing in the APD 116 (e.g., shader programs), any other software, or any combination thereof. In various examples, the hardware includes any of the processors illustrated (e.g., processor 102, APD 116), or other circuitry or processors not illustrated. In this disclosure, phrases such as “the APD 116 performs a task” is sometimes used. This should be understood as meaning that any technically feasible element (e.g., the software or hardware) performs such task. In addition, although various operations are described as being performed by the APD 116, in other examples, such operations are performed by other elements such as the processor 102 or another hardware or software element not described. Herein, where it is stated that software performs an operation, this should be understood as meaning that software executing on a processor performs the operation and thus that the processor performs that operation.

As a whole, the operations of FIG. 4 involve five “phases”: a visibility and marking phase, a shading rate determination phase, a shade space texture shading phase, a regularization operation and a reconstruction phase. The shade space texture shading phase includes shading onto shade space texture for a scene. The shade space textures can be thought of as “canvases” to which shading operations are applied. The canvases are applied to the objects of a scene in the reconstruction phase. It is possible to decouple the rate at which the shade space shading phase occurs from the rate at which the reconstruction phase occurs, providing benefits such as reduction of shading operation workload.

As described above, the objects of a scene each have one or more shade space textures. The shade space textures are mapped to the surfaces of such objects and colors in the shade space textures are applied to the objects during reconstruction 406. Utilizing the shade space textures in this manner allows for shading operations (e.g., the shade space shading operations 404) to occur in a “decoupled” manner as compared with the other rendering operations.

The visibility and shade space marking pass 402 involves determining and marking which portions of the shade space textures are visible in a scene. In some examples, the scene is defined by a camera and objects within the scene, as well as parameters for the objects. In some examples, a portion of a shade space texture is visible in the event that that portion appears in the final scene. In some examples, the portion appears in the final scene if the portion is within the camera view, faces the camera, and is not occluded by other geometry. In some examples, the visibility pass and shade space marking operation 402 results in generating groups of samples, such as tiles, that are to be shaded in the shade space shading operation 404. Each tile is a set of texture samples of a shade space texture that is rendered into in the shade space shading operation 404 and then applied to the geometry in the reconstruction 406 operation. In some examples, each such tile is a fixed size (e.g., 8×8 texture samples or “texels”).

A rate controller operation 403 applies spatially-adaptive techniques to identify one or more subsets of samples from the portions of the shade space texture designated as visible by the visibility for shading in the shade space shading pass 404. In some examples, the spatially-adaptative sampling techniques used in rate controller operation 403 only sparsely designate a subset of the samples needed for reconstruction. As discussed more fully below, the spatially-adaptive techniques are operable on a group of spatially coherent samples in the shade space, which could be organized in a tile or any other arbitrary spatial arrangement.

The shade space shading operation 404 includes shading the visible portions of the shade space textures according to spatially-adaptive shading rate, and regularization operation 405 regularizes the samples and generates missing samples for filtering. In some examples, the shading operations are operations that are typically applied in the pixel shader stage 316 in “typical” rendering. Such operations include texture sampling (including filtering), applying lighting, and applying any other operations that would be performed in the pixel shader stage 316.

The reconstruction operation 406 includes applying the shade space textures to the geometry of the scene to result in a final image. In some examples, the reconstruction operation 406 processes the scene geometry through the world space pipeline, including applying the operations of the vertex shader stage 304 (e.g., vertex transforms from world-space to screen space) and the rasterizer stage 314 to generate fragments. The reconstruction operation 406 then includes applying the shade space texture to the fragments, e.g., via the pixel shader stage 316, to produce a final scene which is output via the output merger stage 318. Note that the operations of the pixel shader stage 316 in reconstruction 406 are generally much simpler and less computationally intensive than the shading operations that occur in the shade space shading operations 404. For example, while the shade space shading operations 404 perform lighting, complex texture filtering, and other operations, the reconstruction operation 406 is able to avoid many such complex pixel shading operations. In one example, the reconstruction operation 406 performs texture sampling with relatively simple filtering and omits lighting and other complex operations.

As stated above, it is possible to apply the shade space shading operation 404 at a different frequency than the reconstruction operation 406. In other words, it is possible to use the information generated by the shade space operation 404 to reduce the computational workload of the complex shading operations 404. The decoupled shading operations 400 will now be described in greater detail.

FIG. 5 illustrates operations for the visibility pass and texture marking operations 402, according to an example. Herein, the term “visibility pass 402” is used interchangeably with “visibility pass and texture marking operations 402.” The example visibility pass 402 is performed for a scene 502 which includes a number of objects 504. In addition, each object 504 has an associated shade space texture 506 which has a visible portion 508 and a non-visible portion 509. As can be seen, the example visibility pass 510 results in the designation of the visible portion 508 of the associated shade space texture 506.

In an example 512, the visibility pass 402 designates the visible portions 508 of the shade space textures 506 by generating tiles 514 that cover the visible portions in the following manner. The visibility pass 402 performs operations of the graphics processing pipeline 134 and generates tiles for the portions of the shade space texture 506 that are visible in the scene. Each tile 514 represents a portion of the shade space texture 506 that is to be shaded in the shade space shading operation 404. Tiles that are not generated are not shaded in the shade space operation 404.

In some examples, the visibility pass 402 generates tiles by using the graphics processing pipeline 134. More specifically, the geometry of the scene 502 is processed through the graphics processing pipeline 134. Information associating each fragment with a shade space texture flows through the graphics processing pipeline 134. When the final image is generated, this information is used to identify which portions of which shade space textures 506 are actually visible. More specifically, because only visible fragments exist in the final output image, the information associated with such fragments is used to determine which portions of the shade space textures 506 are visible.

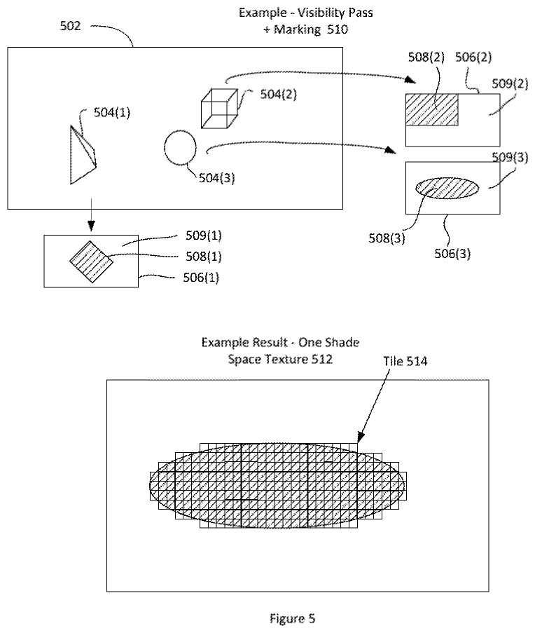

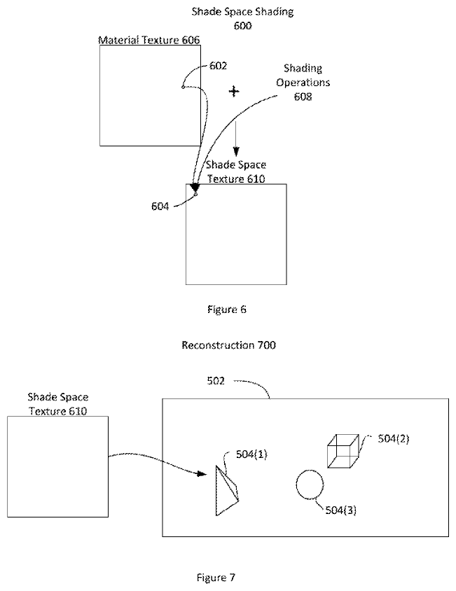

FIG. 6 illustrates example shade space shading operations 600 for the shade space shading operations 404 of FIG. 4. The APD 116 performs shade space shading 600 by sampling a material texture 606 within a sample area 602 to obtain a texture color and applying shading operations 608 (e.g., lighting and/or other operations) as a result to generate a shade space color sample 604 for the shade space texture 610. In some examples, the shade space shading operations 600 generates texels for the entirety of each of the tiles 514 that are generated as a result of the visibility pass 402. FIG. 7 illustrates an example reconstruction operation 700. In the reconstruction operation 700, the shade space texture 610 is applied to the objects 504 within the scene. As stated elsewhere herein, in some examples, this application is performed via texture sampling operations that sample the shade space texture 610 and apply such samples to the objects 504 of the scene 502.

One problem with decoupled shading solutions is that they suffer from higher baseline shading costs. To maintain high image quality, the shading rates have to be higher than the sample rates of the final image according to the sampling theorem. The techniques discussed below solve this problem, allowing the spatial shading rates to be reduced while maintaining high image quality. While the system shown in FIG. 4 is useful for limiting the shading operation to portions of the shade space texture designated for shading by the visibility pass, rate controller operation 403 can achieve a further lessening of shading operations through application of spatially-adaptive shading techniques to those portions of the shade space texture designated as visible by the visibility pass.

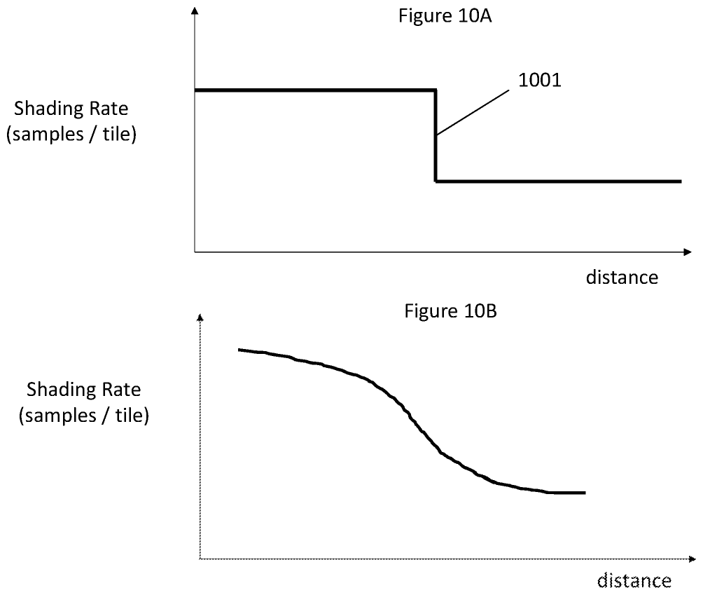

As discussed above, the decoupled shading system generates the final image from a set of samples from a shade space. In some examples, the spatially-adaptative sampling techniques discussed herein only sparsely shade a subset of the samples needed for reconstruction. The techniques are operable on a group of spatially coherent samples in the shade space, which could be organized in a tile or any other arbitrary spatial arrangement. In some examples of shading rate controller operation 403, the spatially-adaptive techniques select subsets of samples to be shaded in the shade space shading pass 404, guided by various shading criteria, reconstruction pass 406, and/or in accordance with a target spatial shade rate (or spatial shade rate budget). In some examples, these sparsely shaded samples drive a feedback loop in rate controller operation 403. In these examples, the spatial rate control system is driven by shading feedback, either local or global, pre-analysis of scene content (e.g., textures), knowledge of the specularity and shadow edges and/or any other static or dynamic results of the shading operation with impact to the spatial frequency of the signal that could be easily estimated. In some examples, the sample selection for shading is performed stochastically with a sample group, influenced by sampling criteria. Additionally, in some examples, spatial rate equalization is applied as discussed in connection with FIG. 10B (below) to a one or more neighboring tiles to reduce banding artifacts that could result from sudden shade rate changes.

As discussed above, the spatially-adaptative sampling techniques only sparsely shade a subset of the samples needed for reconstruction. The spatially-adaptive techniques described herein are different from known implementations of decoupled shading that shade all samples at a reduced level of detail in the shade space. Out of all of the samples that exist in the shade space textures, the spatially-adapting sampling techniques discussed herein shade only a subset of those samples. The term “sparse shading operation” as used herein refers to the shading of only such a subset of the samples. Prior to the final image reconstruction phase, a sample regularization step (e.g., using interpolation or prediction) is performed on available, sparsely shaded samples to generate missing samples needed by the reconstruction filter. This allows for simpler and more controllable filter implementation. As an example of this, hole filling of samples is performed on a regular grid. In some examples, the spatially-adaptive shading approach discussed herein has fine-grained control of shading rates all the way down to individual samples (as opposed to tiles or blocks of the shade or image space) and takes into account the importance of samples according to their potential contribution to the image. In other embodiments, the spatially-adaptive shading techniques are applied across tiles or groups of tiles. Various examples of the spatially-adaptive shading techniques are discussed below.

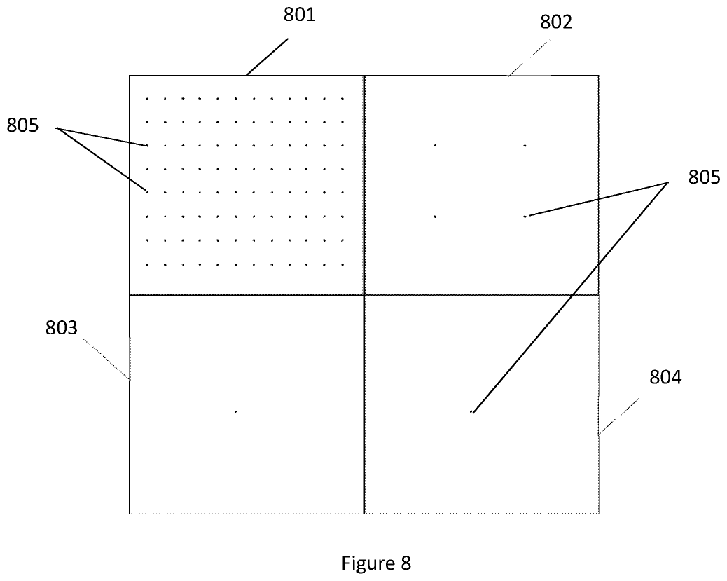

FIG. 8 illustrates the implementation of spatially-adaptive shading rates, according to an example. In the example, the adaptive shading technique operate across tiles by shading samples at a relatively high spatial rate in some tiles, and at a lower spatial sampling rate in other tiles. In the example, visibility pass 402 identified tiles 801, 802, 803 and 804 as visible, and the shading rate controller 403 determined specific spatial shading rate for each of the tiles 801, 802, 803, and 804. Specifically, the shading rate controller 403 determined that tile 801 should have a relatively high spatial rate of samples 805, while tiles 802, 803 and 804 should have a much lower shading rate. In one implementation of this example, the shading rate controller 403 selects the shading rate for each tile based on the shaded content of the tile.

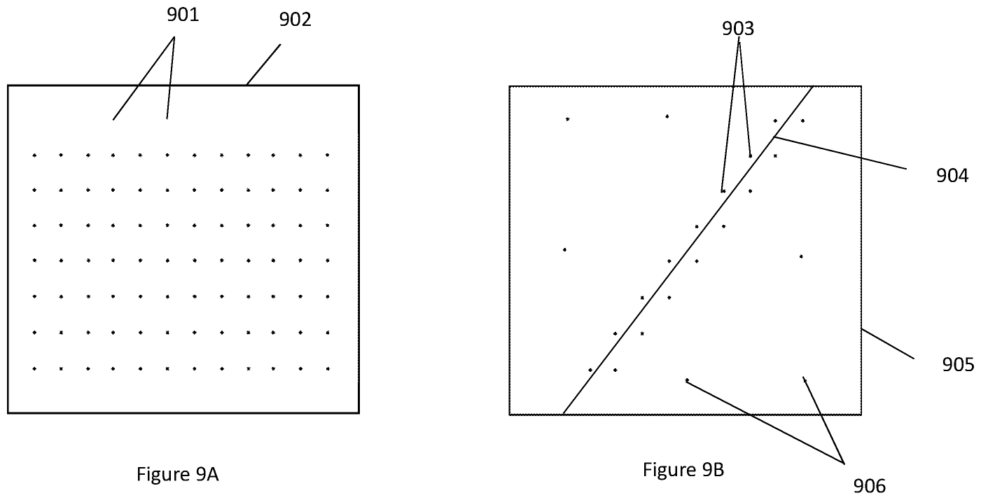

A further example, an adaptive shading technique operates within a tile by shading samples at a relatively high spatial rate near a high-frequency detail, while shading at a more coarse spatial rate elsewhere in a tile. FIG. 9A illustrates the use of regularly-spaced samples 901 in shade space texture tile 902. In an example, the regularly-spaced samples 901 include all of the samples for the shade space textures. By contrast, FIG. 9B illustrates the clustering of samples 903 at a high spatial rate around high-frequency detail 904 in tile 905, and using a reduced spatial rate for samples 906 in the areas of the tile which are more distant from detail 904. In other words, in some examples, FIG. 9B illustrates the sparse shading technique in which the shade space shading pass 404 only shades some samples of a tile. As described, for the sample regularization, the shade space shading pass 404 generates the missing samples through regularization (e.g., by interpolating the shaded samples). Although some work is associated with regularization, this work is less than the work associated with shading.

In one example, the shading rate controller 403 determines the resolution of the clustering of samples 903 proximate high-frequency detail 804 based on a preterminal budget of shaded samples within tile 905. There are many options for defining budgetary constraints depending on requirements. In one example, when a stable frame rate delivery is a goal, the number of shaded samples that could be processed in a frame could be estimated by dividing the allotted frame time by the average cost of shading per unit of time. In other cases, the budget could be adjusted based on the content in either static or dynamic manner. For example, if the shading rate controller 403 is aware of the happening of an explosion that will add a lot of pixel processing due to smoke particles, it could artificially increase the budget to account for such event. Within the budget, an optimum spatial amount and/or pattern of samples proximate detail 904 are selected for shading in order to minimize the visual and perceptible impact of applying on a subset of the samples to the shading operation. In other words, in these examples, the shading rate controller 403 identifies samples that are proximate to detail (e.g., with one or n pixels of detail in the full-resolution grid such as that shown in FIG. 9A) as samples that should be shaded in the shade space shading pass 404, and identifies a much more sparse subset of samples that are not proximate to the detail, as samples to be shaded in the shade space shading pass 404.

FIGS. 10A and 10B illustrate equalization of the spatial rate of samples between shade space texture tiles 801, 802, 803 and 804 in FIG. 8, according to an example. As mentioned above, in the example of FIG. 8, visibility pass 402 identified tiles 801, 802, 803 and 804 as visible, and the shading rate controller 403 determined specific shading rate resolution for each of the tiles. As shown, the shading rate controller 403 determined that tile 801 should have a relatively high spatial rate of samples 805, while tiles 802, 803 and 804 should have a much lower spatial shading rate. Step 1001 shown in the graph of FIG. 10A, illustrates an abrupt change in spatial sampling rate between tile 801 and adjacent tiles 802, 803 and 804. In other words, the graph of FIG. 10A illustrates the shading rate as compared with tile position. Additionally, step 1001 illustrates an abrupt change in shade rate between adjacent tiles. Such an abrupt change in the spatial shading rate may result in undesirable banding artifacts. The graph of FIG. 10B illustrates a spatial shade rate equalization solution for reducing such artifacts. When the adaptive spatial sampling would otherwise result in situation like that shown in FIG. 8, the spatial sample rate in the surrounding tiles 802, 803 and 804 is biased in favor of more samples in order to smooth the spatial sampling rate across tile boundaries, as shown in FIG. 10B. More specifically, in an example, the shading rate controller 403 first determines an initial shading rate for tiles based on any technically feasible factor such as the factors described elsewhere herein. Subsequently, the shading rate controller 403 smooths these shading rates across tiles. In an example, the shading rate controller 403 applies a post-processing filter to the shading rates determined for multiple tiles in an area. The filter adjusts the shading rates such that a smoother shading rate transition occurs. In other example, when the shading rate controller 403 performs its rate estimation, it considers the current or prior spatial shading rate rates of the neighboring tiles and performs equalization as inline processing. In various implementations the rate equalization could be constrained to the tile being processed by the rate controller, or it could be applied to a neighborhood. The shading rate controller 403 uses any technically feasible manner to adjust the shading rates such that a smoother shading rate transition occurs.

In some example, rate controller operation 403 uses a feedback process to control the spatially-adaptive techniques. In the feedback process, rate controller operation initially determines which samples to shade. The shade space operation 404 then shades the samples. At a subsequent time, the rate controller operation 403 is performed again to determine a different set of samples to shade, after which the sample are shaded in the shade space operation 404. Subsequently, the rate controller operation 403 determines a frequency of the content and/or if a variation in the number and/or position of the samples shaded by the shade space operation 404 actually generated different information than would have been derivable from just one set or the other. For example, through interpolation, rate controller operation 403 interpolates between the colors of one sample pattern and positions of another sample pattern and determines differences. Based on the degree of the differences, the rate controller operation 403 determines which one of these samples are necessary for shade space operation 404, and then either adjusts up, adjusts down or holds constant the number of samples, and/or dithers a position of samples, designated to be shaded during shade space operation 404. Each time rate controller operation 403 goes through this process to determine whether or not to adjust the number and/or pattern of samples, and/or a frequency of the content, will be referred to as an iteration of the feedback process.

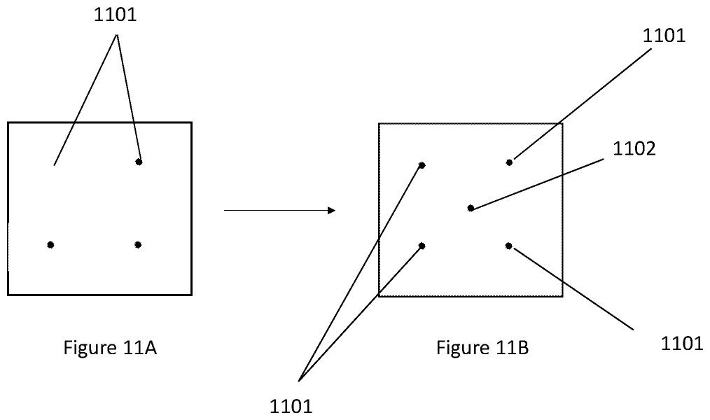

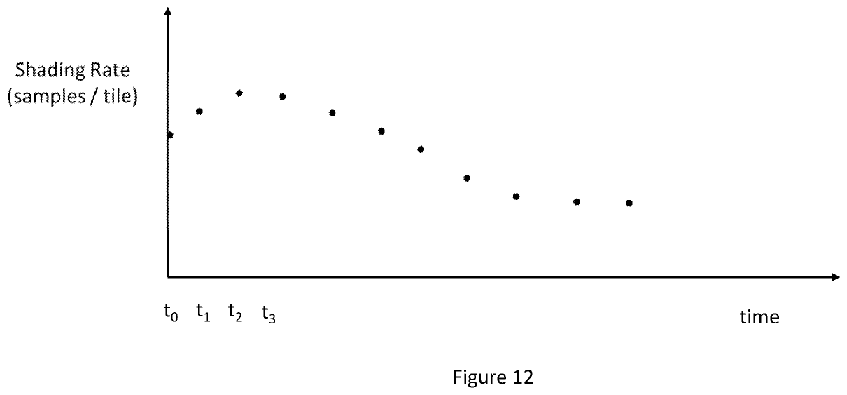

FIGS. 11A and 11B, together with FIG. 12, illustrate a feedback technique for adding additional spatial samples, according to an example. Although a specific collection of samples is illustrated in this example, shade rate controller 403 is operable to apply the feedback technique to any collection of samples in any iteration of the feedback process. In FIG. 11A, rate controller 403 initially selects a spatial sampling rate corresponding to 4 samples 1101 (see FIG. 12) for the shade space operation 404. At a subsequent iteration corresponding to time t₁, rate controller 403 increases the spatial sharing rate (increasing the number of shaded samples) and changes the sample patterns accordingly. In another example, at time t₁, the rate controller 403 increases the shading rate by adding a further additional sample (e.g., sample 1102), but does not change the previous sample locations. In other cases, at time t₁, the rate controller 403 completely changes the sample pattern. Rate controller operation 403 then determines whether the change resulted in increased information. In an example, if the change results in an output different from an interpolation result that could otherwise be calculated from the four surrounding shaded samples 1101, then rate controller 403 determines that the change results in increased information. In such a case, at time t₂, the rate controller 403 increases the spatial sharing rate and changes the sample patterns accordingly. In another example, at time t₂, the rate controller 403 increases the shading rate by adding a further additional sample, but does not change the previous sample locations. In other cases, at time t₂, the rate controller 403 completely changes the sample pattern. Again, rate controller 403 determines that the change results in increased information, and the process is repeated for subsequent iterations. The feedback process will continue until an output no different from (or within a threshold of) an interpolation result that could otherwise be calculated from the four surrounded shaded samples. In other examples, only some of the existing samples are reshaded for the purpose of the error estimation, or spatial variance across the shaded samples is used to estimate the required spatial rate.

In the example shown in FIG. 12, the feedback system implemented by rate controller 403 begins reducing the spatial sampling at t₃ to determine whether reduction in the spatial sampling rate can be achieved without loss of information. After each of the points shown in FIG. 12, the system uses feedback from the previous iteration to determine whether to increase, decrease or hold constant the spatial sampling rate in the next iteration. One or more if the iterations could be performed per rendered frame time.

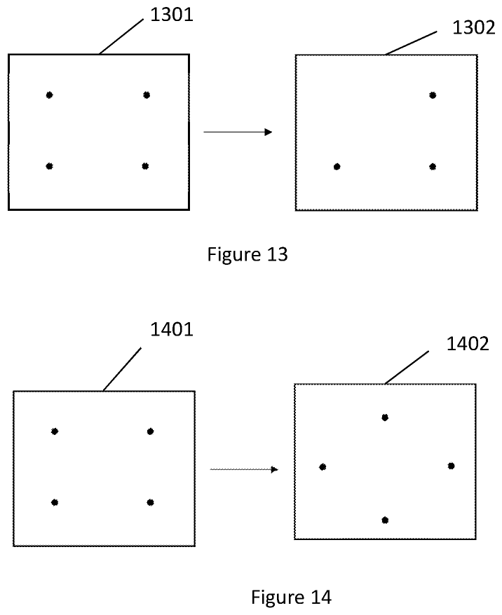

FIG. 13 illustrates an exemplary pattern for adding or subtracting samples for use with the feedback mechanism shown in FIG. 12. Again, although a specific pattern of samples is illustrated in this example, shade rate controller 403 is operable to apply the feedback technique to any pattern of samples in any iteration of the feedback process. In tile 1301, rate controller 403 identifies a spatial sampling rate corresponding to 4 samples in a first iteration and these samples are shaded by space operation 404. In a subsequent iteration of the feedback process illustrated by tile 1302, the rate controller operation 403 subtracts one of the four samples from the pattern, resulting in the designation of only 3 samples for the shade space operation. Subsequently, rate controller 403 determines whether the shading of one less sample resulted in decreased information. In an example, if shading of one fewer sample fails to result in an output different from the result that could otherwise be calculated from four samples as shown in tile 1301, then the shading of one fewer sample is determined to result in no loss of information. In such a case, at a subsequent iteration, rate controller operation 403 will remove a further additional sample (resulting in a spatial sampling rate corresponding 2 samples for the tile), and the feedback process will continue until the rate control operation 403 determines that removal of an additional sample results is a threshold loss of information. While in FIG. 13, samples are added and subtracted from the corners of a square or rectangular pattern, it will be understood that any suitable pattern for addition and subtraction of samples is within the scope of this disclosure. Likewise, more than a single sample could be added or subtracted in a single processing step.

FIG. 14 illustrates an example for performing spatially-adaptive shading where the position of samples is dithered. The dithering illustrated in this figure can be used in conjunction with a feedback mechanism that operates similarly to FIGS. 12 and 13, except that, rather than adding/subtracting samples from iteration to iteration, the number of samples remains constant and the position of the samples is dithered in order to identify an optimal sampling pattern. Again, although a specific pattern of samples is illustrated in this example, shade rate controller 403 is operable to apply the feedback technique to any pattern of samples in any iteration of the feedback process. In tile 1401, rate controller 403 identifies a spatial sampling rate corresponding to 4 samples arranged in the rectangular pattern shown in a first iteration, and these samples are shaded by shade space operation 404. In a subsequent iteration of the feedback process illustrated by tile 1402, the rate controller operation 403 dithers the pattern of the four samples by rotating the rectangular pattern by 45 degrees. Subsequently, rate controller 403 determines whether the shading of the samples in the dithered positions shown in tile 1402 resulted in increased information. In an example, if dithering of the samples result in an output that yields increased information, then in a subsequent iteration, rate controller operation 403 will apply the dithered pattern shown in tile 1402 or designate a different dither pattern to assess whether it results in an increase or loss of information. The feedback process will continue until the rate control operation 403 determines an optimal dither pattern. While in FIG. 13, samples are added and subtracted from a pattern and in FIG. 14 the number of samples remains constant and the pattern is dithered, in some examples the feedback process is used to both dither the sample positions and vary the number of samples between iterations in order to optimize results.

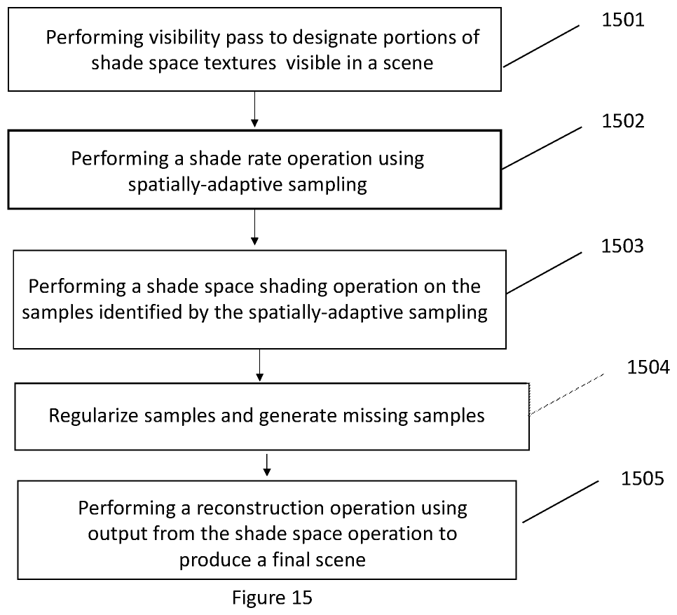

FIG. 15 is a flow diagram of a method for performing spatially-adaptive shading. In step 1501, visibility pass and texture marking operation 402 performs a visibility pass which designates portions of shade space textures visible in a scene. The visibility pass generates tiles that cover the shade space textures visible in the scene. In step 1502, a rate control operation 403 is performed on the tiles that cover the shade space textures visible in the scene using spatially-adaptive sampling. In step 1503, shade space operation 403 performs shading of the samples identified by the rate controller 403 to generate texels for the tiles that cover the shade space textures visible in the scene. In step 1504, regularization operation 405 regularizes the samples and generates missing samples for filtering. In step 1505, a reconstruction operation is then performed to produce a final scene.

In some examples, the rate controller 403 applies spatially-adaptive sampling technique operates by sampling at a higher spatial sampling rate proximate a high-frequency detail in a tile, and sampling at a lower spatial sampling in other areas of the tile. Also in some examples, the rate controller 403 combines spatially-adaptive sampling with the equalization of a spatial sampling rate between neighboring tiles in order to reduce a rate of change the spatial sampling rate between the neighboring tiles.

In some examples, the rate controller 403 use spatially-adaptive sampling techniques as part of a feedback loop to optimize the spatial sampling rate and/or pattern that is used. In one example, the rate controller 403 optimizes the spatial sampling rate in accordance with a predetermined budget of samples to be shaded in the shade space operation.

It should be understood that many variations are possible based on the disclosure herein. Although features and elements are described above in particular combinations, each feature or element can be used alone without the other features and elements or in various combinations with or without other features and elements.

Each of the units illustrated in the figures represent hardware circuitry configured to perform the operations described herein, software configured to perform the operations described herein, or a combination of software and hardware configured to perform the steps described herein. For example, the processor 102, memory 104, any of the auxiliary devices 106, the storage 108, the command processor 136, compute units 132, SIMD units 138, input assembler stage 302, vertex shader stage 304, hull shader stage 306, tessellator stage 308, domain shader stage 310, geometry shader stage 312, rasterizer stage 314, pixel shader stage 316, or output merger stage 318 are implemented fully in hardware, fully in software executing on processing units, or as a combination thereof. In various examples, such “hardware” includes any technically feasible form of electronic circuitry hardware, such as hard-wired circuitry, programmable digital or analog processors, configurable logic gates (such as would be present in a field programmable gate array), application-specific integrated circuits, or any other technically feasible type of hardware.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for rendering, the method comprising:
performing a visibility pass that designates portions of shade space textures visible in a scene, wherein the visibility pass generates tiles that cover the shade space textures visible in the scene;
performing a rate controller operation on output of the visibility pass using spatially-adaptive sampling;
performing a sparse shade space shading operation on the tiles that cover the shade space textures visible in the scene based on a result of the spatially-adaptive sampling;
performing a regularization operation based on an output of the sparse shade space shading operation; and
performing a reconstruction operation using output from the regularization operation to produce a final scene.

2. The method of claim 1, where the spatially-adaptive sampling comprises sampling at a higher spatial sampling rate proximate a high-frequency detail in a tile, and sampling at a lower spatial sampling in other areas of the tile.

3. The method of claim 1, wherein the spatially-adaptive sampling comprises equalization of a spatial sampling rate between neighboring tiles in order to reduce a rate of change the spatial sampling rate between the neighboring tiles.

4. The method of claim 1, wherein the spatially-adaptive sampling comprises:
(i) changing a spatial sampling rate within a tile,
(ii) determining whether the changed spatial sampling rate provides additional information during the shade space shading operation, and
(iii) determining whether to further vary the spatial sampling rate within the tile in response to the result of step (ii).

5. The method of claim 1, wherein the spatially-adaptive sampling comprises:
(i) dithering a spatial sampling pattern within a tile,
(ii) determining whether the dithered spatial sampling pattern provides additional information during the shade space shading operation, and
(iii) determining whether to further dither a spatial sampling pattern within the tile in response to the result of step (ii).

6. The method of claim 1, wherein the spatially-adaptive sampling is implemented in accordance with a predetermined budget of samples to be shaded in the shade space operation.

7. The method of claim 6, wherein an optimum spatial amount of samples are selected for the shade space operation in order to minimize the visual and perceptible impact of applying only a subset of the samples to the shading operation.

8. The method of claim 1, wherein an optimum pattern of samples are selected for the shade space operation in order to minimize the visual and perceptible impact of applying only a subset of the samples to the shading operation.

9. The method of claim 1, wherein:
the reconstruction operation is part of a sequence of reconstruction frames;
the shade space shading operation is part of a sequence of shade space shading frames; and
the sequence of reconstruction frames is processed at a higher frequency than the sequence of shade space shading frames.

10. A system comprising:
a processor; and
a memory storing instructions that, when executed by the processor, cause the processor to perform operations including:
performing a visibility pass that designates portions of shade space textures visible in a scene, wherein the visibility pass generates tiles that cover the shade space textures visible in the scene;
performing a rate controller operation on output of the visibility pass using spatially-adaptive sampling;
performing a sparse shade space shading operation on the tiles that cover the shade space textures visible in the scene based on a result of the spatially-adaptive sampling;
performing a regularization operation based on an output of the sparse shade space shading operation; and
performing a reconstruction operation using output from the regularization operation to produce a final scene.

11. The system of claim 10, wherein the spatially-adaptive sampling comprises sampling at a higher spatial sampling rate proximate a high-frequency detail in a tile, and sampling at a lower spatial sampling in other areas of the tile.

12. The system of claim 10, wherein the spatially-adaptive sampling comprises equalization of a spatial sampling rate between neighboring tiles in order to reduce a rate of change the spatial sampling rate between the neighboring tiles.

13. The system of claim 10, wherein the spatially-adaptive sampling comprises:
(i) changing a spatial sampling rate within a tile,
(ii) determining whether the changed spatial sampling rate provides additional information during the shade space shading operation, and
(iii) determining whether to further vary the spatial sampling rate within the tile in response to the result of (ii).

14. The system of claim 10, wherein the spatially-adaptive sampling comprises:
(i) dithering a spatial sampling pattern within a tile,
(ii) determining whether the dithered spatial sampling pattern provides additional information during the shade space shading operation, and
(iii) determining whether to further dither a spatial sampling pattern within the tile in response to the result of (ii).

15. The system of claim 10, wherein:
the reconstruction operation is part of a sequence of reconstruction frames;
the shade space shading operation is part of a sequence of shade space shading frames; and
the sequence of reconstruction frames is processed at a higher frequency than the sequence of shade space shading frames.

16. The system of claim 10, wherein the spatially-adaptive sampling is implemented in accordance with a predetermined budget of samples to be shaded in the shade space operation.

17. The system of claim 16, wherein an optimum spatial amount of samples are selected for the shade space operation in order to minimize the visual and perceptible impact of applying only a subset of the samples to the shading operation.

18. The system of claim 10, wherein an optimum pattern of samples are selected for the shade space operation in order to minimize the visual and perceptible impact of applying only a subset of the samples to the shading operation.

19. A non-transitory computer-readable medium storing instructions that, when executed by a processor, cause the processor to perform operations comprising:
performing a visibility pass that designates portions of shade space textures visible in a scene, wherein the visibility pass generates tiles that cover the shade space textures visible in the scene;
performing a rate controller operation on output of the visibility pass using spatially-adaptive sampling;
performing a sparse shade space shading operation on the tiles that cover the shade space textures visible in the scene based on a result of the spatially-adaptive sampling;
performing a regularization operation based on an output of the sparse shade space shading operation; and
performing a reconstruction operation using output from the regularization operation to produce a final scene.

20. The non-transitory computer-readable medium of claim 19, wherein the spatially-adaptive sampling comprises sampling at a higher spatial sampling rate proximate a high-frequency detail in a tile, and sampling at a lower spatial sampling in other areas of the tile.
